(19) United States
(12) Patent Application Publication
(10) Pub. No.: US 2024/0344876 A1
(43) Pub. Date: Oct. 17, 2024

(54) WEIGHING MACHINE

(71) Applicant: TNA Australia Pty Limited, Sydney Olympic Park NSW (AU)

(72) Inventor: Nigel David Hoffman, Sydney (AU)

(73) Assignee: TNA Australia Pty Limited, Sydney Olympic Park NSW (AU)

(21) Appl. No.: 18/635,434

(22) Filed: Apr. 15, 2024

(30) Foreign Application Priority Data
Apr. 16, 2023 (AU) 2023901118

(51) Int. Cl. G01G 13/02

(52) U.S. Cl. CPC G01G 13/024

(57) ABSTRACT

There is disclosed herein a weighing machine (100) comprising: a plurality of buckets (20, 25); a chute assembly including: a generally upright central longitudinal axis (15); and a plurality of chutes (40) extending outwardly relative to the axis (15), wherein each chute (40) is configured to deliver product to a respective one of the buckets (20, 25); and a centre cone (135) operatively associated with the chute assembly, the centre cone (135) being configured to deliver product to the plurality of chutes (40), the centre cone (135) including: a base portion (170) that extends in a direction that is generally transverse to the central longitudinal axis (15); and a hub portion (175) including a side wall (180) that extends upwardly from the base portion (170) towards a top plate (185), wherein the top plate (185) provides a first drop point for product being delivered to the weighing machine (100), the base portion (170) provides a first release point for product being delivered from the centre cone (135) to each chute (40), and each chute (40) provides a second drop point for product being delivered from the centre cone (135).

### CROSS-REFERENCE TO RELATED APPLICATION

This application claims priority to Australian Patent Application No. 2023901118, filed on 16 Apr. 2023. The entire disclosure of Australian Patent Application No. 2023901118 is hereby incorporated by reference in its entirety and for all purposes.

### FIELD

The present invention relates to weighing machines (scales). In particular, the present invention relates to chutes employed in weighing machines that weigh and deliver the product in packages to a packaging machine via a former.

The invention has been developed primarily for use with product distribution chutes for the packaging of snack foods, and will be described hereinafter with reference to these applications. However, it will be appreciated that the invention is not limited to this particular field of use, and may also be employed in other applications and systems involving product distribution chutes for weighing machines.

### BACKGROUND

In the packaging industry, particularly relating to the packaging of snack foods such as crisps, weighing machines (scales) receive product from a cross feeder located above the weighing machine. The weighing machine subsequently delivers the product, in batches, to a packaging machine located below the weighing machine. The weighing machine may include a first set of buckets (hoppers) which accumulate the product, and then deliver the product to a second set of buckets which weigh the product. The second set of buckets are then actuated so that batches of product having a desired weight are delivered to a former, and then ultimately to the packaging machine below.

The weighing machine typically includes a centre cone to which product is initially delivered from the slip conveyor. The centre cone directs the product to a plurality of chutes that extend generally radially and downwardly from the cone to the first set of buckets. The weighing machines have a generally upright central longitudinal axis, with each of the distribution chutes having a longitudinal axis located in a plane passing through the longitudinal axis. Accordingly, the chutes extend radially relative to the longitudinal axis.

A disadvantage of the above arrangement is that product that is delivered to the centre cone is typically unable to be directed or distributed to the chutes in a controlled fashion. The product being delivered to the weighing buckets may therefore be distributed unevenly, resulting in some buckets being under or over the target product weight. Food products which have an inconsistent shape or size, such as potato chips/crisps and corn chips, for example, typically have a low fluidity or predictability about their movement, which may cause clumping and interlocking as they move towards the chutes. The interlocked product then falls from the end of the radial chutes in clumps, resulting in a surge of product and therefore an uncontrolled or excessive weight in the buckets. Food product from the cross feeder is also often delivered to the centre cone at an offset from its central longitudinal axis due to changes in feed rate, causing changes to the trajectory and drop point of the food product. Such arrangements may provide less desirable outcomes in respect of the weight control of the product being delivered to the buckets and may impact the overall efficiency of the weighing machine.

### SUMMARY

It is an object of the present invention to substantially overcome, or at least ameliorate, one or more of the disadvantages of existing arrangements, or at least provide a useful alternative to existing arrangements.

There is disclosed herein a weighing machine comprising:
a plurality of buckets;
a chute assembly including:
   a generally upright central longitudinal axis; and
   a plurality of chutes extending outwardly relative to the axis, wherein each chute is configured to deliver product to a respective one of the buckets; and
a centre cone operatively associated with the chute assembly, the centre cone being configured to deliver product to the plurality of chutes, the centre cone including:
   a base portion that extends in a direction that is generally transverse to the central longitudinal axis; and
   a hub portion including a side wall that extends upwardly from the base portion towards a top plate,
wherein the top plate provides a first drop point for product being delivered to the weighing machine, the base portion provides a first release point for product being delivered from the centre cone to each chute, and each chute provides a second drop point for product being delivered from the centre cone.

In one or more embodiments, a distance between the first release point and the second drop point approaches or is as close as possible to a single-layer bed depth of the product being delivered to the buckets.

In one or more embodiments, the centre cone has a stepped configuration. In such embodiments, the side wall of the hub portion may have a height of less than approximately 25 mm.

In one or more embodiments, the side wall of the hub portion extends at an angle of approximately 55 degrees relative to the vertical.

In other embodiments, the center cone has a flat configuration. In such embodiments, the side wall of the hub portion has a height that is zero or approaches zero.

In one or more embodiments, a distance between the centre cone and a floor of each chute is zero or approaches zero.

In one or more embodiments, small vibrations are imparted upon centre cone to allow the product to circulate around the centre cone.

In one or more embodiments, a distance between the first release point and the second drop point is between approximately 10 and 30 mm. In some embodiments, the distance between the first release point and the second drop point is approximately 15 mm.

In one or more embodiments, a floor of each chute has a stepped arrangement. In some embodiments, the floor includes a first floor portion and a second floor portion separated by a stepped portion. In some embodiments, the stepped portion has a height of between 5 and 30 mm.

In one or more embodiments, the centre cone has an overall thickness of between approximately 0.85 mm to 1.25 mm.

A centre cone adapted for use with a weighing machine having a plurality of buckets and a chute assembly located above the buckets, the centre cone being configured to deliver product to the chute assembly, the centre cone including:
a central longitudinal axis;
a base portion that extends in a direction generally transverse to the central longitudinal axis;
a hub portion including a side wall that extends upwardly from the base portion towards a top plate,
wherein the top plate provides a first drop point for product being delivered to the weighing machine, the hub portion provides a first release point for product being delivered from the centre cone to the chute assembly, and the chute assembly provides a second drop point for product being delivered from the centre cone.

In one or more embodiments, a distance between the first release point and the second drop point approaches or is as close as possible to a single-layer bed depth of the product being delivered to the buckets.

In one or more embodiments, the centre cone has a stepped configuration. In such embodiments, the side wall of the hub portion has a height of less than approximately 25 mm.

In one or more embodiments, the side wall of the hub portion extends at an angle of approximately 55 degrees relative to the vertical

In other embodiments, the center cone has a flat configuration. In such embodiments, the side wall of the hub portion has a height that is zero or approaches zero.

In one or more embodiments, a distance between the centre cone and a floor of the chute assembly is zero or approaches zero.

In one or more embodiments, small vibrations are imparted upon centre cone to allow the product to circulate around the centre cone.

In one or more embodiments, a distance between the first release point and the second drop point is between approximately 10 and 30 mm. In some embodiments, the distance between the first release point and the second drop point is approximately 15 mm.

In one or more embodiments, the centre cone has an overall thickness of between approximately 0.85 mm to 1.25 mm.

There is further disclosed herein a weighing machine comprising:
a plurality of buckets;
a chute assembly including:
   a generally upright central longitudinal axis; and
   a plurality of chutes extending outwardly relative to the axis, wherein each chute is configured to deliver product to a respective one of the buckets; and
a centre cone operatively associated with the chute assembly, the centre cone being configured to deliver product to the plurality of chutes, the centre cone including a base portion that extends in a direction generally transverse to the central longitudinal axis,
wherein the base portion provides a first drop point for product being delivered to the weighing machine and a first release point for product being delivered from the centre cone to each chute, and each chute provides a second drop point for product being delivered from the centre cone.

In one or more embodiments, a distance between the first release point and the second drop point approaches or is as close as possible to a single-layer bed depth of the product being delivered to the buckets.

In one or more embodiments, the center cone has a flat configuration.

In one or more embodiments, a distance between the centre cone and a floor of each chute is zero or approaches zero.

In one or more embodiments, small vibrations are imparted upon centre cone to allow the product to circulate around the centre cone.

In one or more embodiments, a distance between the first release point and the second drop point is between approximately 10 and 30 mm. In some embodiments, the distance between the first release point and the second drop point is approximately 15 mm.

In one or more embodiments, a floor of each chute has a stepped arrangement. In some embodiments, the floor includes a first floor portion and a second floor portion separated by a stepped portion. In some embodiments, the stepped portion has a height of between 5 and 30 mm.

In one or more embodiments, the centre cone has an overall thickness of between approximately 0.85 mm to 1.25 mm.

There is further disclosed herein a centre cone adapted for use with a weighing machine having a plurality of buckets and a chute assembly located above the buckets, the centre cone being configured to deliver product to the chute assembly, the centre cone including:
a central longitudinal axis;
a base portion that extends in a direction generally transverse to the central longitudinal axis;
wherein the base portion provides a first drop point for product being delivered to the weighing machine and a first release point for product being delivered from the centre cone to the chute assembly, and the chute assembly provides a second drop point for product being delivered from the centre cone.

In one or more embodiments, a distance between the first release point and the second drop point approaches or is as close as possible to a single-layer bed depth of the product being delivered to the buckets.

In one or more embodiments, the center cone has a flat configuration.

In one or more embodiments, a distance between the centre cone and a floor of the chute assembly is zero or approaches zero.

In one or more embodiments, small vibrations are imparted upon centre cone to allow the product to circulate around the centre cone.

In one or more embodiments, a distance between the first release point and the second drop point is between approximately 10 and 30 mm. In some embodiments, the distance between the first release point and the second drop point is approximately 15 mm.

In one or more embodiments, the centre cone has an overall thickness of between approximately 0.85 mm to 1.25 mm.

There is further disclosed herein a weighing machine comprising:
a plurality of buckets;
a chute assembly including:
   a generally upright central longitudinal axis; and
   a plurality of chutes extending outwardly relative to the axis, wherein each chute is configured to deliver product to a respective one of the buckets; wherein each chute includes:
      an inlet portion and an outlet portion, wherein the inlet portion is located closer to the axis than the outlet portion, and wherein the outlet portion is spaced radially relative to the axis from the inlet portion; and
      a longitudinally extending floor defining a chute passage extending between the inlet portion and the outlet portion, the chute passage being configured for product to flow therealong, wherein the floor includes a first floor portion and a second floor portion separated from the first floor portion by a stepped portion; and
a centre cone operatively associated with the chute assembly, the centre cone being configured to deliver product to the plurality of chutes, the centre cone including:
   a base portion that extends in a direction that is generally transverse to the central longitudinal axis; and
   a hub portion including a side wall that extends upwardly from the base portion towards a top plate,
wherein the top plate provides a first drop point for product being delivered to the weighing machine, the hub portion provides a first release point for product being delivered from the centre cone to each chute, and each chute provides a second drop point for product being delivered from the centre cone.

In one or more embodiments, a distance between the first release point and the second drop point approaches or is as close as possible to a single-layer bed depth of the product being delivered to the buckets.

In one or more embodiments, the centre cone has a stepped configuration. In such embodiments, the side wall of the hub portion has a height of less than approximately 25 mm.

In one or more embodiments, the side wall of the hub portion extends at an angle of approximately 55 degrees relative to the vertical.

In other embodiments, the center cone has a flat configuration. In such embodiments, the side wall of the hub portion has a height that is zero or approaches zero.

In one or more embodiments, a distance between the centre cone and a floor of each chute is zero or approaches zero.

In one or more embodiments, small vibrations are imparted upon centre cone to allow the product to circulate around the centre cone.

In one or more embodiments, a distance between the first release point and the second drop point is between approximately 10 and 30 mm. In some embodiments, the distance between the first release point and the second drop point is approximately 15 mm.

In one or more embodiments, a floor of each chute has a stepped arrangement. In some embodiments, the floor includes a first floor portion and a second floor portion separated by a stepped portion. In some embodiments, the stepped portion may have a height of between 5 and 30 mm.

In one or more embodiments, the centre cone has an overall thickness of between approximately 0.85 mm to 1.25 mm.

There is further disclosed herein a weighing machine comprising:
a plurality of buckets;
a chute assembly including:
   a generally upright central longitudinal axis; and
   a plurality of chutes extending outwardly relative to the axis, wherein each chute is configured to deliver product to a respective one of the buckets; wherein each chute includes:
      an inlet portion and an outlet portion, wherein the inlet portion is located closer to the axis than the outlet portion, and wherein the outlet portion is spaced radially relative to the axis from the inlet portion; and
      a longitudinally extending floor defining a chute passage extending between the inlet portion and the outlet portion, the chute passage being configured for product to flow therealong, wherein the floor includes a first floor portion and a second floor portion separated from the first floor portion by a stepped portion; and
a centre cone operatively associated with the chute assembly, the centre cone being configured to deliver product to the plurality of chutes, the centre cone including a base portion that extends in a direction generally transverse to the central longitudinal axis,
wherein the base portion provides a first drop point for product being delivered to the weighing machine and a first release point for product being delivered from the centre cone to each chute, and each chute provides a second drop point for product being delivered from the centre cone.

In one or more embodiments, a distance between the first release point and the second drop point approaches or is as close as possible to a single-layer bed depth of the product being delivered to the buckets.

In one or more embodiments, the center cone has a flat configuration.

In one or more embodiments, a distance between the centre cone and a floor of each chute is zero or approaches zero.

In one or more embodiments, small vibrations are imparted upon centre cone to allow the product to circulate around the centre cone.

In one or more embodiments, a distance between the first release point and the second drop point is between approximately 10 and 30 mm. In some embodiments, the distance between the first release point and the second drop point is approximately 15 mm.

In one or more embodiments, the centre cone has an overall thickness of between approximately 0.85 mm to 1.25 mm.

### BRIEF DESCRIPTION OF THE DRAWINGS

For a more complete understanding of the present invention, exemplary embodiments of the invention are explained in more detail in the following description with reference to the accompanying drawing figures, in which like reference signs designate like parts and in which:

FIG. 1 is a schematic isometric view of a standard weighing machine and associated chutes of a packaging machine;

FIG. 2 is an enlarged schematic isometric view of the portion A shown in FIG. 1;

FIG. 3 is a schematic isometric view of a weighing machine and associated chutes of a packaging machine according to one embodiment;

FIG. 4 is an enlarged schematic isometric view of the portion B shown in FIG. 3;

FIG. 5 is a schematic top plan view of the weighing machine shown in FIG. 3;

FIG. 6 is an enlarged schematic section view along portion A-A shown in FIG. 5;

FIG. 7 is an enlarged schematic section view of the standard weighing machine shown in FIG. 1;

FIG. 8 is a further enlarged schematic section view along portion A-A shown in FIG. 5;

FIG. 9 is a further enlarged schematic section view of the standard weighing machine shown in FIG. 1;

FIG. 10 is a further enlarged schematic section view along portion A-A shown in FIG. 5;

FIG. 11 is an exemplary view of the weighing machine showing a typical distribution of product;

FIG. 12 is an exemplary view of the weighing machine showing a distribution of product with a center cone according to one embodiment; and

FIG. 13 is a schematic top plan view of twin-scale arrangement according to another embodiment.

### DETAILED DESCRIPTION

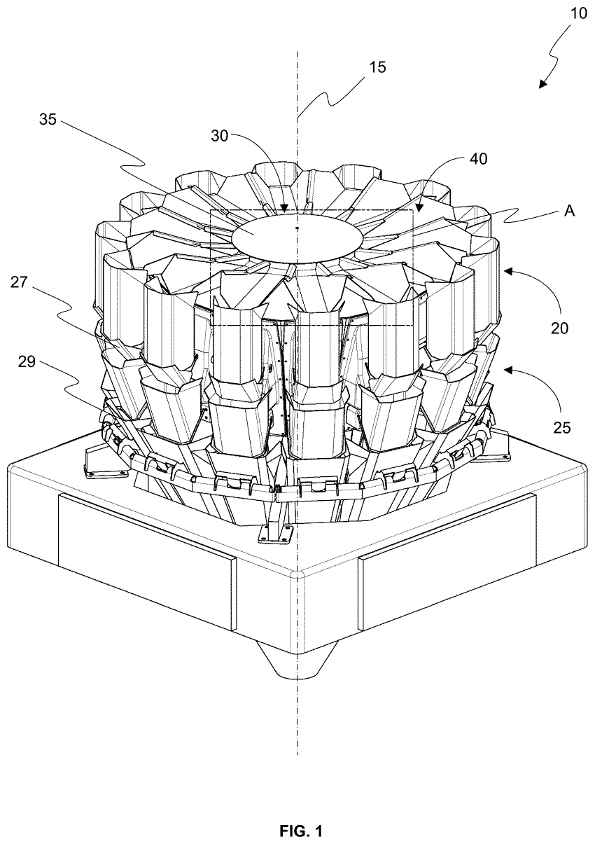

In FIGS. 1, 2, 7, and 9 of the accompanying drawings, there is schematically depicted a standard weighing machine 10. As an example, the weighing machine 10 may be scales employed in the packaging industry to deliver batches of product to a packaging machine (not shown) located below the weighing machine 10. The product may be in the form of snack foods such as potato chips, corn chips, or extrusions.

The weighing machine 10 has a generally upright central longitudinal axis 15. Arranged around the axis 15 is a first set of buckets 20, commonly referred to as hoppers, which receive and store product for delivery to a second set of buckets 25 located below the first set of the buckets 20, which weigh the product. A selected number of the second set of buckets 25 may be actuated or opened so that batches of product having a desired weight are delivered to the packaging machine below.

In the examples shown in the Figures, the weighing machine 10 includes fourteen of the first buckets 20 and fourteen of the corresponding second buckets 25. It will, however, be appreciated that the number and configuration of the first and second buckets 20 and 25 are not necessarily limited to the number and configuration indicated above or shown in the drawings, and may be adjusted depending on the design requirements of the weighing machine 10. In the interest of clarity, not all of the buckets 20 and 25 are accorded a reference numeral in the Figures.

Each bucket of the first set of buckets 20 is provided with a door 27 that is movable between an open position and a closed position. When one or more of the doors 27 of the first set of buckets 20 are opened, the product is delivered to the second set of buckets 25. Similarly, each bucket of the second set of buckets 25 is provided with a door 29 that is movable between an open position and a closed position. In the interest of clarity, not all of the doors 27 and 29 are accorded a reference numeral in the Figures. When one or more of the doors 29 of the second set of buckets 25 are opened, the product is delivered to (lower) chutes located below the weighing machine 10, the lower chutes leading to a former that then delivers the product to the packaging machine.

The weighing machine 10 further includes a central cone assembly 30 having a centre cone 35 to which product from a cross-feeder (not shown) is initially delivered. It is understood that in most arrangements, the product from the cross-feeder is often delivered to the centre cone at an offset from the central longitudinal axis 15. The centre cone 35 may be operatively associated with a chute assembly, as will be described below, and may be fastened to a frame or other component of the weighing machine 10 by conventional fastening mechanisms.

In the example of FIGS. 1, 2, 7, and 9, the centre cone 35 has a downwardly sloping conical surface that directs product under the influence of vibration and gravity to a plurality or assembly of (upper) product distribution chutes 40 that extend radially from the centre cone 35 towards the first set of buckets 20. In the interest of clarity, not all of the chutes 40 are accorded a reference numeral in the Figures. It will be understood that the plurality of product distribution chutes 40 include the same central longitudinal axis 15 described above with respect to the overall weighing machine 10.

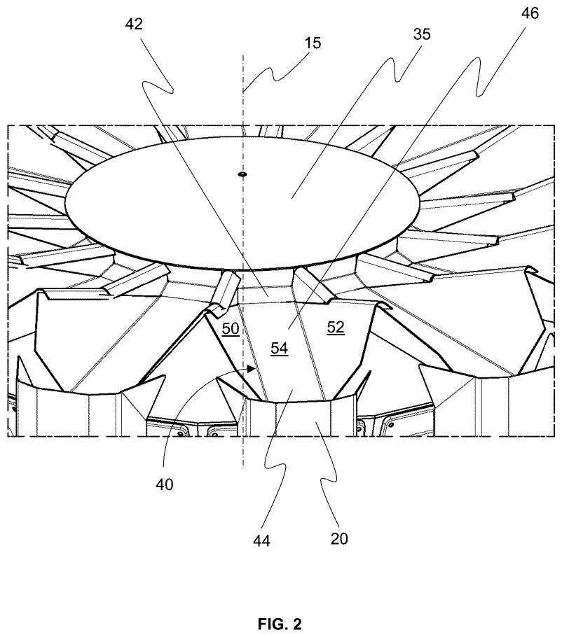

In the example shown in FIG. 2, the product distribution chutes 40 may each include an inlet end portion 42 and an outlet end portion 44, with each chute 40 having a longitudinal passage 46 along which the product flows or moves. Each outlet end portion 44 may be spaced further from the central longitudinal axis 15 than the associated inlet end portion 42. Each outlet end portion 44 may be also spaced radially relative to the axis 15 from the inlet end portion 42. Each passage 46 may be generally linear as shown in the Figures, or alternatively slightly curved (not shown) about the axis 15.

Each chute 40 may include a pair of side walls 50 and 52, as well as a floor 54 from which the side walls 50 and 52 upwardly extend. In the depicted Figures, the walls 50 and 52 are each inclined at an angle relative to the floor 54. The floor 54 may extend from the inlet end portion 42 to the outlet end portion 46 in a direction that is transverse to the central longitudinal axis 15, whereby product may flow therealong under the influence of vibration and gravity.

It is understood that in typical arrangements, and as best shown in FIG. 7, the conical surface of the centre cone 35 may slope downwardly at an angle α of approximately 15 degrees relative to the horizontal. In such arrangements, product being delivered to the weighing machine 10 typically follows a path 60 from the cross-feeder, onto the conical surface of the centre cone 35 at a first drop point A1, dropping onto the floor 54 of each chute 40 from a first release point B1 to a second drop point C1, into the first set of buckets 20 from a second release point D1, and subsequently into the second set of buckets 25. In the example as shown in FIG. 7, a portion 65 of the path 60 (i.e. the distance between the first release point B1 and the second drop point C1) illustrates a height at which product travels or falls from the conical surface of the centre cone 35 onto the floor 54 of each chute 40. In typical arrangements for snack foods, the portion or height 65 may be approximately 50 mm.

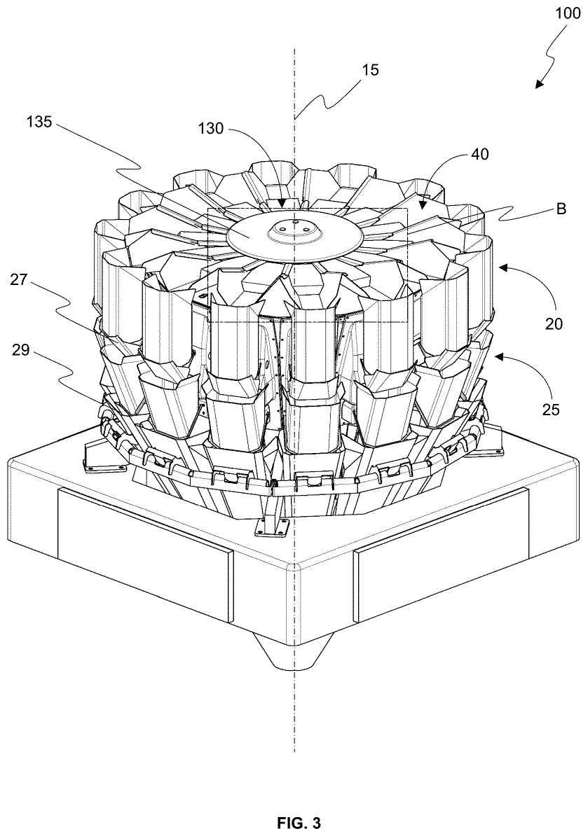

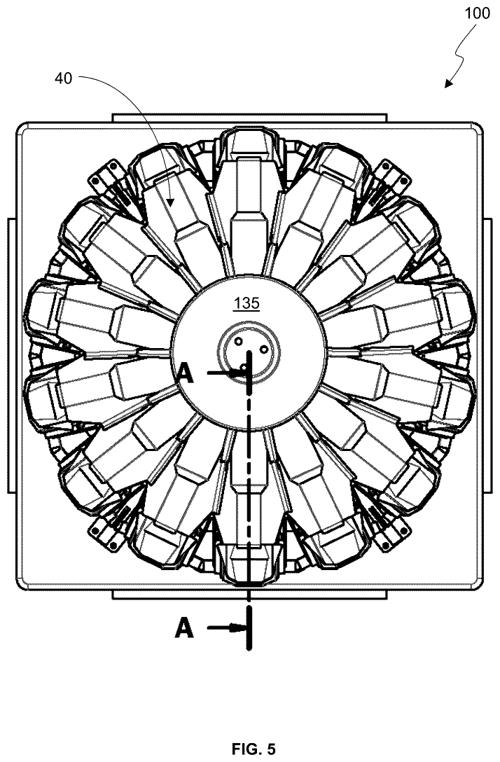

In FIGS. 3 to 6, 8, and 10 of the accompanying drawings, there is schematically depicted an embodiment of a weighing machine 100 which functions in a similar manner to the weighing machine 10 described above, with like reference numerals being used to describe like features. In the interest of clarity, not all like features will be accorded a like reference numeral in the drawings, the description of the like features of this embodiment may not be repeated, and it will be understood that any one or more of the like features or functions of the embodiment of the weighing machine 10 above may be applicable to the embodiment of the weighing machine 100. In this embodiment, the weighing machine 100 includes a central cone assembly 130 having a stepped or flat centre cone 135 to which the product is initially delivered.

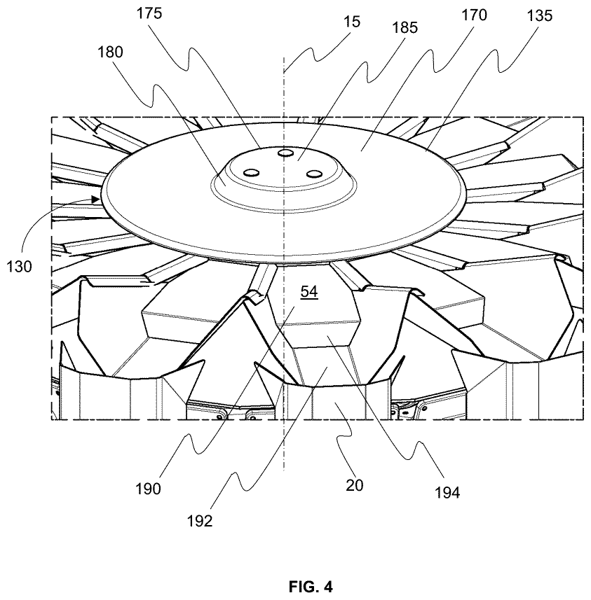

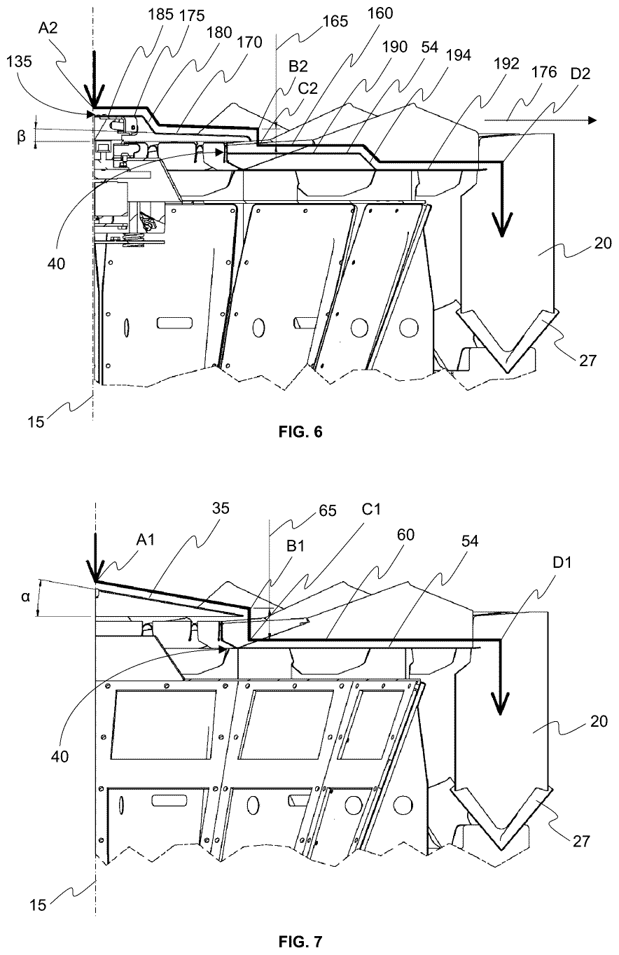

As best shown in FIG. 4, the centre cone 135 includes a base or outer portion 170. In embodiments whereby the centre cone 135 has a stepped configuration, the center cone 135 may further include a hub or inner portion 175. Referring to FIG. 6, the base portion 170 has a generally flat or planar arrangement in which the planar surface of the base portion 170 extends in a direction 176 that is transverse to and radially outwardly from the central longitudinal axis 15. It will be understood that the centre cone 135 includes the same central longitudinal axis 15 described above with respect to the overall weighing machine 100. The direction of extension of the planar surface may be approximately 90° relative to the central longitudinal axis 15 (i.e. generally parallel to the horizontal axis). In the depicted embodiment, the planar surface of the base portion 170 slopes gently downwardly at an angle β relative to the horizontal. The angle β may be approximately 3 degrees or less. In a preferred form, the planar surface of the base portion 170 may slope downwardly at an angle β of approximately 2 degrees relative to the horizontal. In other forms (not shown) whereby the centre cone 135 is substantially flat, the planar surface of the base portion 170 does not slope downwardly such that the angle β may be zero or as close as possible to zero.

In some embodiments, the centre cone 135 may be provided as a separate component and retro-fitted to an existing weighing machine. For example, the centre cone 135 may replace the centre cone 35 described above in relation to the standard weighing machine 10. In such embodiments, the centre cone 135 may be operatively associated with a chute assembly, as will be described below, and may be fastened to a frame or other component of the weighing machine 10 above the chutes 40 using a single bolt or any other suitable fastening mechanism.

The centre cone 135 may have an overall thickness of between approximately 0.85 to 1.25 mm. In some embodiments, the overall thickness of the centre cone 135 may be approximately 0.90 mm. In one form, the overall thickness of the centre cone 135 may be approximately 0.89 mm. In some embodiments, the centre cone 135 may be formed from stainless steel or titanium or other suitably rigid material. It will be appreciated that a thinner (and lighter) centre cone 135 may at least allow for its inertial mass to be minimised whilst allowing for the vibrational response to be maximised. As discussed above, small (torsional/rotational) vibrations are imparted upon centre cone 135 to allow the product to circulate around the centre cone 135 and as such, minimising the thickness (and therefore the weight) of the centre cone 135 may at least allow for an increase in the degree of procession (circulation) of the product around the centre cone 135 to the chutes 40. It will be appreciated that the thickness and material of the centre cone 135 is not necessarily limited to the dimensions and materials described above, and may be adjusted depending on the design requirements of the centre cone 135/weighing machine 100.

In embodiments whereby the centre cone 135 has a stepped configuration, the hub portion 175 may have a side wall 180 that extends generally upwardly from the base portion 170 towards a top plate 185. In some embodiments, the side wall 180 may be inclined at an angle of between approximately 40 to 60° relative to the vertical, and may have a height of less than approximately 25 mm. In one form, the side wall 180 may be inclined at an angle of approximately 55° relative to the vertical height of the side wall 180 may be approximately 22 mm. It will be appreciated that the angle and height of the side wall 180 is not necessarily limited to the dimensions described above, and may be adjusted depending on the design requirements of the centre cone 135/weighing machine 100. In another form (not shown) and as briefly described above, the centre cone 135 may be substantially flat such that the height of the side wall 180 is zero or as close as possible to zero. In yet another form (not shown), the centre cone 135 may be entirely flat such that the hub portion 175 and the base portion 170 extend along the same plane (without the side wall 180). Additionally, and as will be described in further detail below, the distance between the centre cone 135 and the floor 54 of each chute 40 may be reduced such that it is zero or as close as possible to zero. It will be appreciated that the stepped or flat arrangement of the centre cone 135 may at least influence the flow of the product being delivered from the cross-feeder to the first set of buckets 20, as will be described in further detail below.

In the depicted embodiment, product being delivered to the weighing machine 100 may follow a path 160 from the cross-feeder, onto the hub portion 175 at a first drop point A2 and along the base portion 170 of the centre cone 135 (whereby the product circulates around the centre cone 135 due to small vibrations being imparted upon the center cone 135), travelling onto the floor 54 of each chute 40 from a first release point B2 to a second drop point C2, into the first set of buckets 20 from a second release point D2, and subsequently into the second set of buckets 25. In the example as shown in FIG. 6, a portion 165 of the path 160 (i.e. the distance between the first release point B2 and the second drop point C2) illustrates a height at which product travels or falls from the base portion 170 of the centre cone 135 (i.e. from the planar surface of the base portion 170) to the floor 54 of each chute 40. Depending on the type of product being delivered to the weighing machine 100, this portion or height 165 may be between approximately 10 and 30 mm. In a preferred form for snack foods such as potato chips, this portion or height 165 may be approximately 15 mm. The portion or height 165 is preferably approaching or as close as possible to a single-layer bed depth of the product that is travelling along the path 160. In embodiments whereby the centre cone 135 is substantially or entirely flat, the distance between the first drop point A2 and the first release point B2 may be zero or as close as possible to zero. It is understood that the stepped or flat arrangement of the centre cone 135 and/or the reduction in the distance between the planar surface of the base portion 170 of the centre cone 135 and the floor 54 of each chute 40 may at least provide a reduction in the portion or height 165 (for example, compared to the portion or height 65 of the typical arrangement shown in FIG. 7).

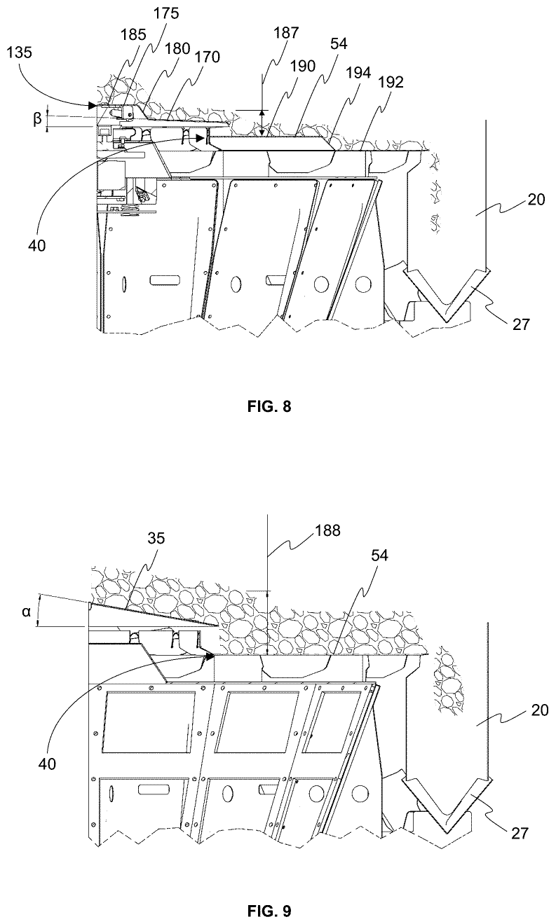

To aid in understanding the effect of the arrangement of the centre cone 135, FIG. 8 provides a visualisation of the path 160 as shown in FIG. 6 (with the stepped or flat centre cone 135), whilst FIG. 9 provides a visualisation of the path 60 as shown in FIG. 7 (with a typical center cone 35 arrangement). In these Figures, the difference in the thickness/bed depth of the product ‘layers’ travelling along the paths 60 and 160 and the resulting flow characteristics is clearly shown. In the example of FIG. 8, the product that travels along the path 160 may have a single-layer bed depth 187 due to a relatively small portion or height 165 (i.e. the distance between the first release point B2 and the second drop point C2). In this embodiment, the portion or height 165 approaches or is as close as possible to the single-layer bed depth 187. This arrangement may at least lead to a continuous flow of product travelling along the path 160 and subsequently into the first set of buckets 20. For snack foods such as potato chips, corn chips, and extrusions, the single-layer bed depth 187 may be between approximately 15 to 30 mm. It will be understood that the single-layer bed depth 187 corresponds to the dimensions of the particular snack food that is being processed. In contrast, in the example of FIG. 9, the product that travels along the path 60 may have a multi-layer bed depth 188 due to a relatively large portion or height 65 (i.e. the distance between the first release point B1 and the second drop point C1). In this arrangement, pieces of the product stack up against each other in multiple layers as they travel along the path 160, thus leading to an undesirable clumping or an ‘avalanche’ in the flow of product that subsequently falls into the first set of buckets 20. As briefly discussed above, clumps or surges in the product may lead to an uncontrolled or excessive weight of product entering the buckets 20. By reducing the portion or height 165 such that it approaches or is as close as possible to the single-layer bed depth of the product, the clumps or surges in the product may be reduced or altogether eliminated, thereby improving the overall efficiency of the weighing machine 100.

It will thus be appreciated that the flow characteristics of the product may be improved by the arrangement of the centre cone 135 as described above, and specifically by reducing the portion or height 165 (i.e. the distance between the first release point B2 and the second drop point C2). In preferred arrangements, the distance between the first release point B2 and the second drop point C2 may be as close as possible to a dimension of an individual piece of the product that is travelling along the path 160. The configuration and dimensions of the centre cone 135 and/or the distance between the centre cone 135 and floors 54 of the chutes 40 may be adjusted depending on the dimensions of the product that is being processed by the weighing machine 10.

In the depicted embodiment, the floor 54 of each chute 40 may have a stepped arrangement. As shown in the Figures, floor 54 may include a first floor portion 190 and a second floor portion 192 separated by a stepped portion 194. It will be appreciated that the stepped portion 194 may at least assist in reducing the drop height of the product between the centre cone 135 and the chute 40. The stepped portion 194 may be inclined at an angle of approximately 45° relative to the vertical, and may have a height of between approximately 5 and 30 mm. It will be understood that the dimensions and configuration of the chute floor 54 are not necessarily limited to the dimensions and configuration as described above, and may be adjusted depending on the design requirements of the weighing machine 10. In some embodiments (not shown), the height of the stepped portion 194 may be up to a height that allows the chute walls 50 and 52 to still contain a single product layer in the chute 40. In other embodiments (not shown), the floor 54 of each chute 40 may not necessarily have a stepped arrangement and may be flat or substantially flat.

In some embodiments, the angle of the slope of the centre cone 135 (i.e. angle β) may be significantly less than angle α of the standard arrangement described above. From the dimensions provided above, angle β may be approximately 85% less than angle α, which may create a significantly gentler incline for the travel path of the product. It will also be appreciated that in some embodiments, the introduction of a “step” in the central cone 135 (or the reduction in the portion or height 165 to create a flat central cone 135) may at least provide a further reduction to the extent of the drop that the product has to make when travelling along the path 160 between the centre cone 135 and the floor 54 of each chute 40. The introduction of an additional further “step”, i.e. the stepped portion 194 of the chute floor 54, may at least provide another further reduction to the extent of the drop that the product has to make when travelling along the path 160 between the centre cone 135 and the floor 54 of each chute 40.

As discussed above, product being delivered to the weighing machine 100 typically follows a path 160 from the cross-feeder, onto the surface of the centre cone 135 (whereby the product circulates around the centre cone 135 due to small torsional/rotational vibrations being imparted upon the center cone 135), travelling onto the floor 54 of each chute 40, and into the first set of buckets 20. The above-described reduction in the angle of the slope of the centre cone 135 and/or the stepped/flat arrangement of the centre cone 135 and/or the stepped portion 194 of the chute floor 54 may at least result in a corresponding reduction or flattening in the bed depth of the product travelling along the path 160, creating a more linear flow at a bed depth approaching the thickness of a single piece of the product and thereby reducing or altogether eliminating the clumping or interlocking of the product. The effects of gravity influencing the flow of the product may be reduced, leading to a more even and consistent distribution of product around the centre cone 135.

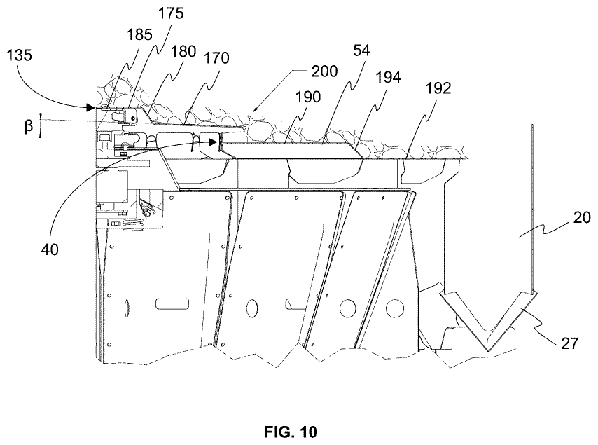

As best shown in FIG. 10, it will be appreciated that the above-described arrangement may create a product ‘dam’ or ‘barrier’ 200 which may at least stop the product from being dropped or fed onto the chutes 40 unless and until the chutes 40 are free from product and thus able to accommodate new product being fed from the centre cone 135. This arrangement may therefore allow for more overall control and consistency in the distribution of the product being circulated from the centre cone 135 to the chutes 40 and subsequently to the first set of buckets 20 and then the second set of (weighing) buckets 25. In the packaging of smaller bags, the consistency in the distribution of product to each bag and the overall weight control is critical to avoid product waste. This is because smaller bags generally contain a small piece count of product, and therefore one or two additional pieces may result in large deviations from the target weight. Considering, for example, a small bag of jelly beans which generally has eight or ten pieces per bag, even one additional jelly bean would result in a 10% weight deviation.

### Experimental Data

It is understood that the primary functions of a multi-head weighing machine are to: a) minimise product ‘Give Away’ (i.e. maximising the number of legal weighments for a given supply or product; and b) perform the above as time efficiently as possible.

Give Away: The Give Away of the combined weighments is characterised by the Mean and Standard Deviation (SD) of the combined weighments. A small SD allows the Mean to be minimised towards the Target Weight. Typical values are extremely product dependent, with the goal being to reduce both values.

Efficiency: Missed cycles typically occur when no valid combined weighments can be found within (Target Weight+Upper Limit), or (Target Weight−Lower Limit). Missed cycles reduce the time efficiency. Typical efficiency requirements are >98%.

In effect, Give Away and Efficiency are opposing forces. In practice, a suitable balance needs to occur. To increase efficiency, it may be necessary to increase the allowed Upper Limit, to avoid missed cycles, and thus increase product Give Away.

Each cycle on a multi-head weighing machine calculates all combinations from the available partial weighments. The closest combination to the Target Weight is discharged. Increasing the number of heads on a weighing machine provides an increased number of combinations from which to select.

A typical multi-head weighing machine has either 10, 14, or 16 individual weigh heads (buckets). The number of weigh heads tends to increase with the required accuracy, also with the required speed of the application. Other methods to effectively increase the number of weigh heads may be utilised such as Memory Buckets that “buffer” weighments allowing the Weigh Buckets to be reused whilst previous weighment await combination. For illustration purposes, the following description, tables, and test results refer to a 14 head weigher, with no memory buckets. This is one of the most common formats produced of multi-head weighing machines. The principles referred to in the following remain the same regardless of whether more or less weigh heads exist.

The weighing machine normally needs to discharge at rates greater than the individual head cycle rate. This means that once a head is selected in a combination and is discharged, it will “miss” at least 1 cycle. As the speed of the application increases, eventually used heads will miss 2 cycles, etc. Thus, it is critical for product flow to be controlled such that the average number of heads used per combination offers the maximum number of combinations from which to choose from.

Tables 1 to 3 below illustrate the “ideal” average head number providing the maximum number of combinations to select from. These are the only 3 speed scenarios that a 14 head weigher can actually operate in. Combinations are obtained using the following standard mathematical combination formulae:

$${nC}_{r} = \frac{n !}{( n - r ) ! r !}$$

where:
   r is the size of each permutation
   n is the size of the set from which elements are permuted

TABLE 1
Ideal heads per combination - SINGLE SHIFT
After use, head available next cycle (SINGLE SHIFT)

| Average Heads per discharge | Unique weight combinations |
|---|---|
| 1 | 14 |
| 2 | 91 |
| 3 | 364 |
| 4 | 1001 |
| 5 | 2002 |
| 6 | 3003 |
| 7 | 3432 |
| 8 | 3003 |
| 9 | 2002 |
| 10 | 1001 |
| 11 | 364 |
| 12 | 91 |
| 13 | 14 |
| 14 | 1 |

TABLE 2
Ideal heads per combination - DOUBLE SHIFT
After use, head misses next cycle (DOUBLE SHIFT)

| Average Heads per discharge | Unique weight combinations |
|---|---|
| 1 | 13 |
| 2 | 66 |
| 3 | 165 |
| 4 | 210 |
| 5 | 126 |
| 6 | 28 |
| 7 | 1 |
| 8 to 14 | 0 |

TABLE 3
Ideal heads per combination - TRIPLE SHIFT
After use, head misses next 2 cycles (TRIPLE SHIFT)

| Average Heads per discharge | Unique weight combinations |
|---|---|
| 1 | 12 |
| 2 | 45 |
| 3 | 56 |
| 4 | 15 |
| 5 to 14 | 0 |

It is understood that Give Away and Efficiency are determined by individual head Mean and SD weight. It is common for a 14 head weighing machine to operate as per Table 2 or 3, with the most common being Table 2 (DOUBLE SHIFT). Note that the combinations for a given number of heads rapidly deteriorate on each side of the “ideal” Average Weigh Heads. Reference is made to both Table 2 and 3 for the typical operating modes. This is why controlling the product flow to each weigh head is so important.

Measuring the Mean and SD of partial weighments (i.e. individual weigh buckets) is the true measure of the product flow control. The optimal weight delivered to each weigh bucket (i.e. partial weighment) should be such that:

$$Mean weight per head = \frac{Target Weight}{“ Ideal ” Average Heads Per discharge}$$

The per weighment Standard Deviation (SD) is influenced by many factors, such as, average piece weights, tendency of product to entangle, and weigher geometries. There is no “rule of thumb” SD ideal for individual heads other than making it as small as possible.

It will thus be appreciated that the arrangement of the weighing machine described above may at least provide the following functions: a consistent and controlled product bed depth on the radial feeders which can approximate a monolayer (i.e. single layer bed depth); allow the precession of product on the main feeder, and simultaneously supply a force such that it can only feed the entry of radial feeders without a monolayer, and otherwise bypass delivery of those radial feeders which currently have a monolayer; and provide a steady and controlled buffer of product on the main feeder. It is understood that the above functions are central to controlling product flow to the weigh buckets such that the Mean Weight per Head is achieved and the SD per head is minimised, thus allowing the weigher to operate such that it selects from the maximal Unique Weight Combinations. Consistently achieving this may result in the minimal product Give Away and highest Efficiency.

In one test set-up, product (thin cut potato crisps) was supplied from a vibratory infeed device (cross feeder) that was ON/OFF controlled by the weigher.

Two variations of the alignment of the infeed device were tested:
(i) product delivery point targeting the centre of the main feeder, and
(ii) product delivery point “offset” from centre. A 100 mm offset was selected to represent the typical maximum misalignment error that occurs during installation of weigher and infeed equipment. This amount of offset generally has negative affects upon Give Away and Efficiency.

The weigher was set to discharge at 110 CPM (Cycles Per Minute). During each test, the weigher was continuously cycled for 560 discharges (˜ 5 minutes).

A combined discharge (i.e. Target Weight) of 20.0 g was programmed with an Upper Limit of 3 g, and a Lower Limit of 0 g. This is “typical” under a minimum weight system. Acceptable maximum weight was thus 23.0 g.

At the 110 CPM set speed, the relative cycle time of weigh heads verses weigher discharges had the weigher operating in Double Shift as per Table 2. Thus, ideal Heads/Discharge=4. Thus, ideal Mean Weight per Head=(20 g/discharge)/(4 head/discharge)=5.0 g/head.

Prior to each test sequence, the weigher was run for an extended period to allow inbuilt auto-tuning functions to individually adjust vibration amplitudes of radial feeders to best achieve 5 g per head. Once values were relatively stabilized, the weigher was paused ready for the test. Counters were reset.

The following results were obtained on the 14 head weigher running 20 g Thin Cut Potato Crisps (product) with and without the centre cone 135 of the present invention with an optimally aligned (i.e. centralised) product infeed:

With the inclusion of the centre cone 135 of the present invention, the average weight per head varied from 4.64 g to 5.98 g. All heads were close to 5 g target. The SD for each head varied between 2.1 g and 3.33 g. The maximum weight delivered into single head was 11.0 to 18.5 g, all below combined target weight requirement and allowing successful future combination. Without the centre cone 135 (i.e. with the standard centre cone 35 arrangement), the average weight per head varied from 5.5 g to 8.8 g despite the 5 g target. The SD for each head varied between 2.4 g and 5.7 g. The maximum weight delivered into single head was 12.5 g to 28.5 g. The 28.5 g result (single head over-weight) is 5.5 g over the 23 g acceptable maximum weight.

In summary, a comparison between the individual head “Average” and “Std.Dev” weights demonstrate that control of product to individual Weigh Buckets 1 to 14 was improved with the inclusion of the centre cone 135 of the present invention. The combined weighments (i.e. the weigher discharges) show improved SD and Mean with the inclusion of the centre cone 135 of the present invention. Product was relatively mono layered in both arrangements, though some radial feeders without the centre cone 135 (i.e. with the standard centre cone 35 arrangement) had an excessive product bed depth beyond a mono layer. A significant performance improvement for a centralised product infeed was therefore observed with the inclusion of the centre cone 135 of the present invention. It is noted that the above results were filtered by this weigher's software to remove the overweight discharges. There was at least 1 of these (28.5 g) in the results obtained above, but possibly several more, as only the highest value is recorded per head.

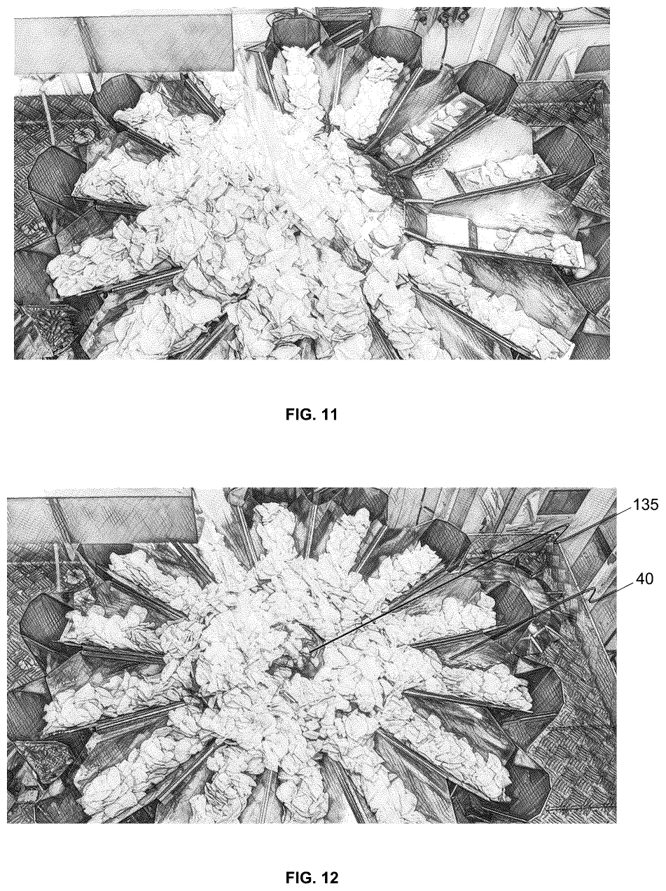

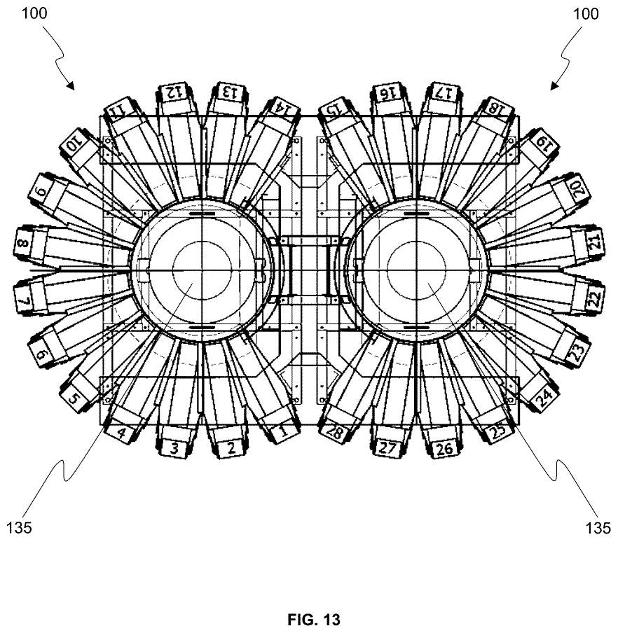

FIG. 11 shows an example of the physical test arrangements and the distribution of product without the centre cone, and FIG. 12 shows an example of the physical test arrangements and the distribution of product with the centre cone. In both FIGS. 11 and 12, the same scales are shown with the same product and same scale settings, with a different result from the inclusion of the centre cone as shown in FIG. 12.

The following results were obtained on the 14 head weigher running 20 g Thin Cut Potato Crisps (product) with and without the centre cone 135 of the present invention with a non-optimal (i.e. 100 mm off-centre) product infeed:

With the inclusion of the centre cone 135 of the present invention, the average weight per head varied from 4.9 g to 5.7 g. This is very close to 5 g target on all 14 heads. The SD for each head was between 2.05 g to 2.79 g. The maximum weight delivered into a single head was 10.9 g to 15.1 g, all below combined target weight requirement and allowing successful future combination. Without the centre cone 135 (i.e. with the standard centre cone 35 arrangement), an average weight per head varied from 2.39 g to 6.74 g despite 5 g target. The SD for each head varied between 1.02 g and 4.96 g. The maximum weight delivered into single head was 5.3 g to 27.5 g. Three of the heads displayed results above 23 g (20 g Target Weight+3 g Upper Limit). These are single head over-weights. As noted previously, the results are only indicative of the highest value and thus 23 g may have been breached multiple times.

In summary, a comparison between the individual head “Average” and “Std.Dev” weights from the results above demonstrate that control of product to individual Weigh Buckets 1 to 14 was improved with the inclusion of the centre cone 135 of the present invention. The combined weighments (i.e. the weigher discharges) show improved SD and Mean with the invention fitted from the results above. Product was relatively mono-layered with the inclusion of the centre cone 135 of the present invention. By comparison, without the centre cone 135 (i.e. with the standard centre cone 35 arrangement), excessive product bed depth, well beyond a mono layer, was found on approximately 50% or 7 heads, yet also product starvation on another 4 heads. A significant performance improvement for a misalignment of the product infeed was therefore observed with the inclusion of the centre cone 135 of the present invention. It is again noted that the above results are filtered to remove the overweight discharges. There were at least 3 of these (26.5 g, 24.7 g, 24.9 g) in the results obtained above, but possibly more, as only the highest value is recorded per head.

In some arrangements known as ‘twin scale’ arrangements, there is an overlap of the chute 40 footprints that may lead to a design that omits around ¼ to ⅓ of the chutes 40 in both scales/weighing machines. This is done to reduce the centre-to-centre distance between two weighing machines and their associated packaging machines below.

In such arrangements, the twin scales are fed with an infeed diverter that diverts the single infeed from the cross-feeder above into one of the two centre cones of the weighing machines. The infeed diverter can also split the feed to direct the product to both weighing machines. However, in such arrangements and even when the weighing machines are fed well, there will always be an excess of product that travels towards some of the chutes but not to other chutes, leading to an uneven distribution of product. The arrangement of the centre cone 135 described above may therefore at least address this problem. An example of this arrangement is shown in FIG. 13.

Although specific embodiments of the invention are illustrated and described herein, it will be appreciated by those of ordinary skill in the art that a variety of alternative and/or equivalent implementations exist. It should be appreciated that the exemplary embodiment or exemplary embodiments are examples only and are not intended to limit the scope, applicability, or configuration in any way. Rather, the foregoing summary and detailed description will provide those skilled in the art with a convenient road map for implementing at least one exemplary embodiment, it being understood that various changes may be made in the function and arrangement of elements described in an exemplary embodiment without departing from the scope as set forth in the appended claims and their legal equivalents. Generally, this application is intended to cover any adaptations or variations of the specific embodiments discussed herein.

It will also be appreciated that in this document the terms “comprise”, “comprising”, “include”, “including”, “contain”, “containing”, “have”, “having”, and any variations thereof, are intended to be understood in an inclusive (i.e. non-exclusive) sense, such that the process, method, device, apparatus or system described herein is not limited to those features or parts or elements or steps recited but may include other elements, features, parts or steps not expressly listed or inherent to such process, method, article, or apparatus. Furthermore, the terms “a” and “an” used herein are intended to be understood as meaning one or more unless explicitly stated otherwise. Moreover, the terms “first”, “second”, etc. are used merely as labels, and are not intended to impose numerical requirements on or to establish a certain ranking of importance of their objects.

1. A weighing machine comprising:
a plurality of buckets;
a chute assembly including:
a generally upright central longitudinal axis; and
a plurality of chutes extending outwardly relative to the axis, wherein each chute is configured to deliver product to a respective one of the buckets; and
a centre cone operatively associated with the chute assembly, the centre cone being configured to deliver product to the plurality of chutes, the centre cone including:
a base portion that extends in a direction that is generally transverse to the central longitudinal axis; and
a hub portion including a side wall that extends upwardly from the base portion towards a top plate,
wherein the top plate provides a first drop point for product being delivered to the weighing machine, the base portion provides a first release point for product being delivered from the centre cone to each chute, and each chute provides a second drop point for product being delivered from the centre cone.

2. The weighing machine according to claim 1, wherein a distance between the first release point and the second drop point approaches or is as close as possible to a single-layer bed depth of the product being delivered to the buckets.

3. The weighing machine according to claim 1, wherein the centre cone has a stepped configuration, and wherein the side wall of the hub portion has a height of less than approximately 25 mm.

4. The weighing machine according to claim 3, wherein the side wall of the hub portion extends at an angle of approximately 55 degrees relative to the vertical.

5. The weighing machine according to claim 1, wherein the center cone has a flat configuration, and wherein the side wall of the hub portion has a height that is zero or approaches zero.

6. The weighing machine according to claim 1, wherein a distance between the centre cone and a floor of each chute is zero or approaches zero.

7. The weighing machine according to claim 1, wherein small vibrations are imparted upon centre cone to allow the product to circulate around the centre cone.

8. The weighing machine according to claim 1, wherein a distance between the first release point and the second drop point is between approximately 10 and 30 mm.

9. The weighing machine according to claim 1, wherein a floor of each chute has a stepped arrangement, wherein the floor includes a first floor portion and a second floor portion separated by a stepped portion, and wherein the stepped portion has a height of between 5 and 30 mm.

10. The weighing machine according to claim 1, wherein the centre cone has an overall thickness of between approximately 0.85 mm to 1.25 mm.

11. A centre cone adapted for use with a weighing machine having a plurality of buckets and a chute assembly located above the buckets, the centre cone being configured to deliver product to the chute assembly, the centre cone including:
a central longitudinal axis;
a base portion that extends in a direction generally transverse to the central longitudinal axis;
a hub portion including a side wall that extends upwardly from the base portion towards a top plate,
wherein the top plate provides a first drop point for product being delivered to the weighing machine, the hub portion provides a first release point for product being delivered from the centre cone to the chute assembly, and the chute assembly provides a second drop point for product being delivered from the centre cone.

12. The centre cone according to claim 11, wherein a distance between the first release point and the second drop point approaches or is as close as possible to a single-layer bed depth of the product being delivered to the buckets.

13. The centre cone according to claim 11, wherein the centre cone has a stepped configuration, and wherein the side wall of the hub portion has a height of less than approximately 25 mm.

14. The centre cone according to claim 13, wherein the side wall of the hub portion extends at an angle of approximately 55 degrees relative to the vertical.

15. The centre cone according to claim 11, wherein the center cone has a flat configuration, and wherein the side wall of the hub portion has a height that is zero or approaches zero.

16. The centre cone according to claim 11, wherein a distance between the centre cone and a floor of the chute assembly is zero or approaches zero.

17. The centre cone according to claim 11, wherein a distance between the first release point and the second drop point is between approximately 10 and 30 mm.

18. The centre cone according to claim 11, wherein the centre cone has an overall thickness of between approximately 0.85 mm to 1.25 mm.

19. A weighing machine comprising:
a plurality of buckets;
a chute assembly including:
a generally upright central longitudinal axis; and
a plurality of chutes extending outwardly relative to the axis, wherein each chute is configured to deliver product to a respective one of the buckets; and
a centre cone operatively associated with the chute assembly, the centre cone being configured to deliver product to the plurality of chutes, the centre cone including a base portion that extends in a direction generally transverse to the central longitudinal axis,
wherein the base portion provides a first drop point for product being delivered to the weighing machine and a first release point for product being delivered from the centre cone to each chute, and each chute provides a second drop point for product being delivered from the centre cone.

20. The weighing machine according to claim 19, wherein a distance between the first release point and the second drop point approaches or is as close as possible to a single-layer bed depth of the product being delivered to the buckets.
